(19) United States
(12) Patent Application Publication
(10) Pub. No.: US 2013/0097659 A1
(43) Pub. Date: Apr. 18, 2013

(54) SYSTEM AND METHOD FOR WHITELISTING APPLICATIONS IN A MOBILE NETWORK ENVIRONMENT

(71) Applicants: Sudeep Das, Bangalore (IN); Jayasankar Divakarla, Bangalore (IN); Amit Dang, Ghaziabad (IN); Praneet Khare, Gurgaon (IN); Alok Shukla, Bangalore (IN)

(72) Inventors: Sudeep Das, Bangalore (IN); Jayasankar Divakarla, Bangalore (IN); Amit Dang, Ghaziabad (IN); Praneet Khare, Gurgaon (IN); Alok Shukla, Bangalore (IN)

(73) Assignee: McAfee, Inc.

(21) Appl. No.: 13/275,293

(22) Filed: Oct. 17, 2011

(51) Int. Cl. G06F 21/24; G06F 15/16; G06F 21/00

(52) U.S. Cl. 726/1; 726/26

(57) ABSTRACT

One or more attributes of an application in a plurality of applications is identified. A reputation score of the application is determined based at least in part on the identified attributes to determining whether the application should be included in a whitelist. The whitelist can be applied against a request to download the application on a mobile device. In some aspects, the whitelist can be generated through automated collection and analysis of applications available for download by one or more different types of mobile devices in one or more networks. In some aspects, the whitelist can be applied by blocking attempts to download applications determined not to be included in the whitelist.

### TECHNICAL FIELD

This disclosure relates in general to the field of computer networks and, more particularly, to a system and a method for whitelisting applications in a mobile network environment.

### BACKGROUND

The field of computer network security has become increasingly important and complicated in today's society. Computer network environments are configured for virtually every enterprise or organization, typically with multiple interconnected computers (e.g., end user computers, laptops, servers, printing devices, etc.). Furthermore, computer and communications networks today encompass mobile devices such as smartphones, tablet computers and the like, which allow users to download and install applications on these devices quickly and with minimal oversight. However, unrestricted access to mobile resources and application programming interfaces by applications of unknown or untrusted origins could result in damage to the user, the device, and the network, if not managed by suitable security architectures and network precautions. Thus, innovative tools are needed to assist IT administrators in the effective control and management of applications on mobile devices within computer and communication network environments.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating components of a system for whitelisting applications in a mobile network environment according to an example embodiment;

FIG. 2 is a simplified diagram illustrating an example application of whitelist in a mobile network environment according to at least one example embodiment;

FIG. 3 is a simplified diagram illustrating another example application of whitelist in a mobile network environment according to at least one example embodiment;

FIG. 4 is a simplified diagram illustrating an example code flow graph according to the present disclosure;

FIG. 5 is a simplified diagram illustrating an example data flow graph according to the present disclosure;

FIGS. 6A-6C is a simplified flow-chart illustrating example operational steps that may be associated with embodiments of the present disclosure; and

FIG. 7 is a bar chart showing an example scenario of a number of applications against reputation score in accordance with this specification.

### DETAILED DESCRIPTION OF EXAMPLE EMBODIMENTS

### Overview

In general, one aspect of the subject matter described in this specification can be embodied in methods that include the actions of identifying one or more attributes of an application in a plurality of applications, determining a reputation score of the application based at least in part on the identified attributes, and determining whether the application should be included in a first whitelist. The whitelist can be applied against a request to download the application on a mobile device.

In another general aspect of the subject matter described in this specification can be embodied in systems that include at least one processor device, at least one memory element, and a mobile application approval engine. The mobile application approval engine, when executed by the at least one processor device, can identify one or more attributes of an application in a plurality of applications, determine a reputation score of the application based at least in part on the identified attributes, determine whether the application should be included in a first whitelist, and apply the whitelist against a request to download the application on a mobile device.

These and other embodiments can each optionally include one or more of the following features. At least one first policy can be associated with the first whitelist and determining whether the application should be included in the first whitelist can be based on compliance of the application with the at least one first policy. The first whitelist can be associated with a first entity, and inclusion of the application should in a second whitelist associated with a second entity can be based at least in part on compliance of the application with the at least one second policy. The first policy can be one of a plurality of policies, each policy in the plurality of policies associated with a particular mobile device manufacturer and/or a particular mobile network service provider. Determining whether the application should be included in a first whitelist can include determining whether the reputation score indicates a level of trustworthiness above that of a threshold reputation score for the first whitelist. A plurality of application can be obtained, including the application, from at least one application source, and it can determined, for each application in the plurality of applications, whether the respective application should be included in the first whitelist. The plurality of applications can include at least one application operable on a first operating system and at least one other application operable on a second, different operating system. The application can be determined to be omitted from the first whitelist and applying the first whitelist includes blocking the downloading of the application on to the mobile device. Applying the first whitelist can include downloading at least a portion of the first whitelist on the mobile device for use by the mobile device in determining whether to allow downloading of at least the application on the mobile device.

Further, these and other embodiments can also each optionally include one or more of the following features. Identifying one or more attributes of the application can include executing the application in a test environment and observing functionality of the application. A developer of the application can be identified together with a reputation for the developer, the reputation score of the application based, at least in part, on the reputation for the identified developer. The reputation for the developer can be based on reputation scores of other applications associated with the developer. Identifying one or more attributes of the application can include identifying one or more events relating to deployment of the application on one or more mobile devices. The events can identify at least one negative security event detected by the one or more mobile devices in connection with operation of the application on the one or more mobile devices. The events can identify one or more network connections made by the application with particular remote server devices. Identifying one or more attributes of the application can further include identifying a reputation of the particular remote server devices. The application can be adapted for operation on each of a plurality of versions of a particular operating system. One or more functions of the application can be identified to determine if the application includes one or more functions included in a set of undesirable functions. Identifying functions of the application can include decompiling the application to obtain a decompiled code, parsing the decompiled code, and creating a code flow graph and a data flow graph. The first whitelist can include a listing of a plurality of applications approved for download onto any one of a particular set of mobile devices.

Some or all of the features may be computer-implemented methods or further included in respective systems or other devices for performing this described functionality. The details of these and other features, aspects, and implementations of the present disclosure are set forth in the accompanying drawings and the description below. Other features, objects, and advantages of the disclosure will be apparent from the description and drawings, and from the claims.

### Example Embodiments

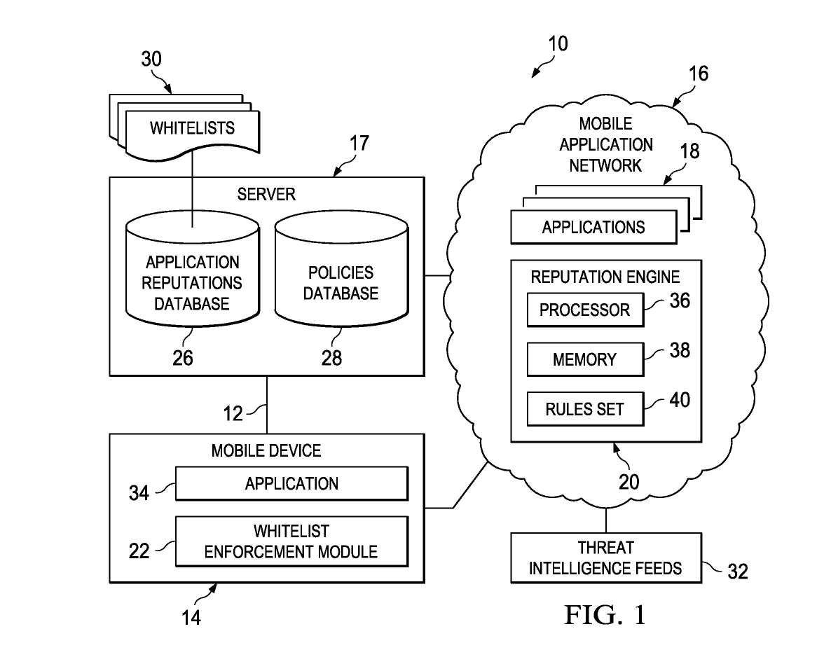

FIG. 1 is a simplified block diagram illustrating an example implementation of a system 10 for whitelisting applications in a mobile network environment. The exemplary environment illustrates a network 12 connecting one or more mobile devices 14 with mobile application network 16. Mobile application network 16 may include one or more computing devices including devices serving one or more mobile applications 18 for download by one or more mobile devices. Mobile application network 16 can further include one or more networks, subnetworks, and connections including shared computing resources, Internet-based servers and network elements, cloud-based computing environments, data centers, enterprise networks, etc. For ease of discussion and illustration, only one mobile device is shown in the FIG. 1. Any number of mobile devices may in fact be connected over network 12 within the broad teachings of the present disclosure. Mobile devices (e.g., mobile device 14), are inclusive of mobile phones, smart mobile phones (smartphones), e-book readers, tablets, iPads, personal digital assistants (PDAs), laptops or electronic notebooks, portable navigation systems, multimedia gadgets (e.g., cameras, video and/or audio players, etc.), gaming systems, other handheld electronic devices, and any other similar device, component, element, or object capable of initiating voice, audio, video, media, or data exchanges within system 10.

In one example embodiment, mobile device 14 may communicate with mobile application network 16 and access one or more applications 18 available in or from mobile application network 16. Mobile applications 18 may be provided, for example, in connection with one or more application software distribution platforms such as Google® Android Market, Apple® App Store, Palm® Software Store and App Catalog, RIM® App World, etc., as well as other sources.

As used herein, “application” or “mobile application” encompasses application software that runs on (or is capable of running on) mobile devices and performs specific tasks for the mobile device's user. In general, applications encompass any software file comprising instructions that can be understood and processed on a computing device, such as for example, executable files, library modules, object files, script files, interpreter files, executable modules and the like. In general, an application may be capable of being decompiled (decompiling is a process of translating a file, such as an executable file, containing information at a relatively low level of abstraction, such as assembly language, into a higher level of abstraction which may be human readable, such as a programming language like C++). Applications may include native applications pre-installed on the mobile device, such as address books, calendars, calculators, games, maps and Web browsers. Applications may also be downloaded from various application software distribution platforms in mobile application network 16. According to embodiments of the present disclosure, application 18 includes any new application and any update to native or downloadable applications. Examples of such mobile applications can include video game applications (or “apps”), map apps, productivity apps, news apps, web browser apps, email apps, e-reader apps, social networking apps, among potentially limitless other examples.

Mobile application network 16 may include a reputation engine 20 for assessing application reputations, also referred to herein as “reputation scores” or “trust scores” (both terms may be interchangeably used throughout the Specification). A reputation score is a value (e.g., numeric, textual, pictorial, etc.) that denotes a relative level of trustworthiness or security of the application on a spectrum (e.g., continuous or discrete) from benign (e.g., reputable) to malicious or unsafe (e.g., non-reputable). The reputation score may indicate a probability that an application is malicious software or otherwise poses a threat to mobile devices or networks upon which it is installed. For example, applications that have a high probability of being malicious may have a high reputation score. In one example scenario, an application that automatically, and without authorization, turns on a camera and a microphone (or other recording device) of a mobile device may be deemed to be insecure, in violations of one or more policies, or malicious. On the other hand, an application that merely accesses the mobile device's processor and memory to facilitate a game of cards may be deemed to be benign.

According to the embodiment illustrated in FIG. 1, each mobile device 14 may be provisioned with one or more whitelist enforcement modules 22 for use in enforcing, at the mobile device 14, whitelists maintained by one or more servers (e.g., 17). Whitelist server 17 may be provisioned with an application reputations database 26 and policies database 28. Policies in policies database 28 may be defined, associated with, assigned or applied by a service provider, device manufacturer, an enterprise manager, or any other appropriate entity. In some embodiments, reputation engine 20 may calculate reputation scores and store the reputation scores in a suitable location along with other information to identify the application. For example, reputation engine 20 may push application reputations to server 17, and server 17 may store the reputation scores and application identification information in application reputations database 26. Server 17 may also support whitelists 30, which may be stored in application reputations database 26. Such whitelists 30 can be based on policies in policies database 28 and indicate applications and/or application actions determined to be in compliance with a corresponding entity's policies. In some embodiments, reputation engine 20 may analyze applications, characterize applications and application functions and other actions as trusted or untrusted, and store trusted applications in a suitable location (e.g., whitelists 30).

In some embodiments, reputation engine 20 may crawl mobile application network 16 (e.g., Internet) for applications, and download and store them in a suitable location, for example, server 17, or in a storage device in communication with reputation engine 20. In other embodiments, reputation engine 20 may collect and aggregate an inventory of applications fingerprints from a plurality of sources such as mobile device 14, application software distribution platforms, threat intelligence feeds 32, etc. As used herein, “application fingerprint” encompasses one or more characteristics of the application (e.g., obtained from the application's manifest, application code, etc.) and/or the application's behavior (e.g., application requests or actions, network activity, etc.) that uniquely identifies the application.

An application manifest includes one or more files that contain details about an application, such as application code, including application functions and variables; application code flow graphs and data flow graphs; unique application identification (ID) tag (e.g., iPhone® App ID number, Android Marketplace ID number, or other series of characters that can uniquely identify an application); application developer identity; application certificate; application name; application capabilities such as camera activation, network connectivity, phone activation, geolocation, etc.; ports and protocols usable by the application; application life span; a geographical origination of the application; a day and/or time of a first and/or latest appearance of the application on a mobile device; files and file hashes associated with the application; country/region where the mobile device is currently located; and geographical locations of subsequent appearances of the application, etc. The application's behavior may include network activity; attack history; ports and protocols actually used by the application; association with other known Internet Protocol (IP) addresses; application requests for resources; and application actions. It will be understood that these types of details are set forth herein for example purposes, and are not intended to be limiting in any manner.

Threat intelligence feeds 32 include threat information from one or more sources internal or external to network 12, such as web reputation engines, file reputation engines, network threat information, internet protocol (IP) and sender reputation engine, vulnerability information, etc. Threat intelligence feeds 32 may be formatted as XML, CSV, simple text files, etc. and can provide real-time, dynamic, and up-to-date information on a variety of potential threats. Threat intelligence feeds 32 may be provided by independent third parties such as security service providers, or by the enterprise's (or the network's) security services. Threat intelligence feeds 32 may be provided to update reputation scores, and/or facilitate analysis of applications by reputation engine 20.

In example embodiments, mobile device 14 may be provisioned with one or more applications 34. Application 34 may be a native application, pre-installed on mobile device 14. According to embodiments of the present disclosure, reputation engine 20 may include a processor 36 and memory 38 for analyzing each application (e.g., application 18) against a rules set 40. Mobile device 14 may be configured to send information to reputation engine 20 and/or permit reputation engine 20 to access information stored on mobile device 14. In an example embodiment, a user may provide permissions to reputation engine 20 to access mobile device 14. In another example embodiment, mobile device 14 may be configured to communicate with reputation engine 20 using authentication protocols, for example, when a user signs up on an Internet site to access services provided by reputation engine 20.

The network environment illustrated in FIG. 1 may be generally configured or arranged to represent any communication architecture capable of electronically exchanging packets. In addition, the network may also be configured to exchange packets with other networks such as, for example, the Internet, or other LANs. Other common network elements (e.g., email gateways, web gateways, routers, switches, loadbalancers, firewalls, etc.), may also be provisioned in the network.

For purposes of illustrating the techniques of system 10, it is important to understand the activities and security concerns that may be present in a given system such as the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

Typical network environments, both in organizations (e.g., businesses, schools, government organizations, etc.) and in homes include a plurality of devices such as end user desktops, laptops, servers, network appliances, and the like, with each device having an installed set of executable software. Users in organizations and homes may also use mobile devices to connect to various wired and/or wireless networks. One difficulty users face when managing their devices in a network environment is ensuring that only trusted and approved executable software files are present on the devices. Although devices in a network may initially be configured with trusted and approved executable software, continuous efforts (both electronic and manual) are usually necessary to protect against unknown and/or malicious software. In particular, users may connect to a network using mobile devices, which may have unique vulnerabilities that hackers may use to spy on the users, or compromise secure information stored on servers and related networked devices.

Certain applications may be unwanted, or even malicious, to a user or a network. Malicious software (malware) includes hostile, intrusive, or annoying programming (e.g., code, script, active content, etc.) that can disrupt or deny operation, gather information that leads to loss of privacy or exploitation, gain unauthorized access to system resources, and exhibit other abusive behavior. For example, an application on a mobile phone could be remotely controlled, and configured to turn on the phone's camera and microphone, permitting spying. In another example, an application may track a user's location and convey that information to unauthorized persons. In yet another example, malicious applications may provide a pathway for unauthorized access to critical and proprietary information, inappropriate use of resources, business interruptions, fraud, and security breaches. Research indicates that rogue applications (e.g., malware and spyware) may be a tremendous problem for the mobile security space.

A system for whitelisting applications outlined by FIG. 1 can resolve these issues, among others. Embodiments of the present disclosure seek to improve capabilities of existing technologies to allow for a more robust solution. Collection and analysis of reputation information may happen in the cloud (e.g., mobile application network 16) for scale, efficiency, and pervasiveness. Mobile devices may be configured to permit access from the cloud to their agents and applications for calculating reputation scores. According to an embodiment of the present disclosure, malware prevention may be based on an updater concept, with reputation scores from mobile application network 16 acting as an update rule. Reputation engine 20 may be included in a server in mobile application network 16. A management console (e.g., running in server 17) may aggregate and store application reputations from reputation engine 20, for example, using an inventory trust synchronizing process. The management console may provide appropriate policies, whitelists (e.g., whitelists 30), inventory exchange, corporate application reputation scores, etc. to suitable whitelist enforcement modules 22 on mobile devices (e.g., mobile device 14).

According to embodiments of the present disclosure, components of system 10 may determine functions used by an application, calculate a reputation score of the application, and analyze the application against a rule set in a back-end process. On the front-end, components of system 10 may take suitable protective actions based on the reputation score and analysis of the application. In some other embodiments, components of system 10 may search a whitelist identifying trustworthy applications to determine whether an application in a mobile device is identified in the whitelist. The trust status of the application can be defined as untrusted if the application is not identified in the whitelist. Suitable action may be taken in the mobile device if the trust status of the application is untrusted.

In example embodiments, reputation engine 20 may determine a reputation score of application 18 by aggregating and evaluating one or more applications fingerprints of application 18 uploaded to reputation engine 20 by one or more sources. For example, the application fingerprint may be sent to reputation engine 20 as a 32-byte fingerprint. In another example embodiment, the aggregated application fingerprint may include application code, containing functions and variables. As used herein, a “function” includes a portion of code within a larger program that performs a specific task and is relatively independent of the remaining code, such as a subroutine, a procedure, a routine, a method, an operation, or subprogram. Examples of functions include: (a) functions that record audio (e.g., Media.RecordAudio( ); (b) functions that send out text messages (e.g., SmaManager.SendTextMessage( ); (c) functions that read contact lists (e.g., contacts.read( ); (d) functions that contact Internet servers (e.g., httpClient.postData( ); etc. In some instances, reputations of identified functions can themselves be assessed and whitelists generated including identified functions conforming to one or more mobile device policies.

In example embodiments, reputation engine 20 may decompile application 18, parse the decompiled code, and create one or more code flow graphs and data flow graphs. In example embodiments, functions used by application 18 may be determined from the code flow graphs and data flow graphs. A code flow graph (also known as a call graph) represents calling relationships between subroutines in the application (e.g., application 18). The code flow graph shows a graphical representation of paths that may be traversed through an application during its execution. A data flow graph represents data dependencies between a number of operations or functions used by the application (e.g., application 18). Any suitable method may be implemented to create the code flow graphs and data flow graphs. For example, commercially available software may be used to generate these graphs. Reputation engine 20 may store the data flow and code flow graphs in a database (not shown) for later analysis. Reputation engine 20 may also associate the graphs with unique identifying information about the application, such as the application ID (e.g., package ID) and hash of the binary DEX file (Android OS application binaries are compiled as DEX files).

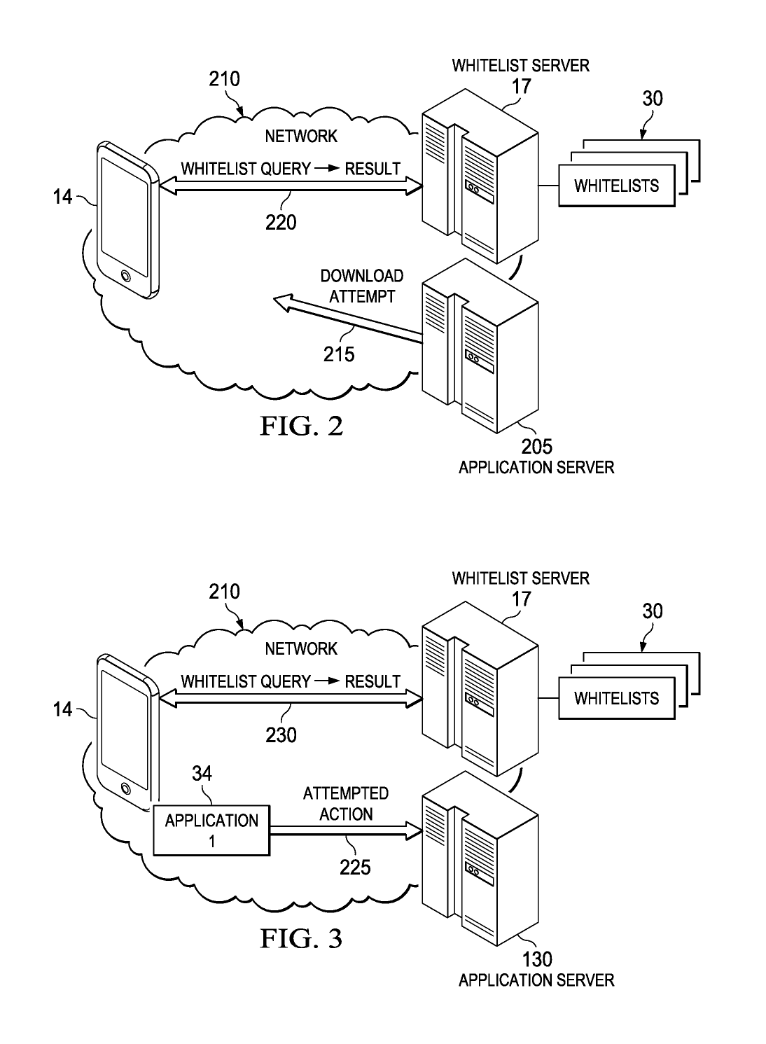

Turning to FIG. 2, according to example embodiments, a reputation system can be utilized to control downloads of applications on mobile devices at least partially under the control of one or more entities, such as a network service provider, device manufacturer, or enterprise. For instance, an example reputation system can protect against end users downloading and/or installing applications onto particular mobile devices serviced by the reputation system that do not conform to policies of the controlling entity, such as applications that are not included in an approved list of applications (i.e., a whitelist). For example, when an end user attempts to download or install a particular application (e.g., at 215) on a mobile device (e.g., mobile device 14), the mobile device (e.g., through whitelist enforcement module 22) may query whitelist server 17 to determine whether the application is included in a corresponding whitelist (e.g., 30). In some examples, mobile device 14 may send the application's identifying information (e.g., application manifest) to server 17 in connection with the query/query result communication 220 between mobile device 14 and whitelist server 17. Server 17 may identify a particular whitelist (i.e., from a set of different whitelists 30) corresponding to the mobile device, its user, network, etc. and perform a whitelist look-up to determine whether the application is included in the whitelist. Accordingly, whitelist server 17 can return results to the mobile device 14. If the query results returned for the application indicate that the application is not included in the whitelist, mobile device 14 (e.g., through whitelist enforcement module 22) can terminate and/or block downloading of the application, terminate and/or block installation of the application, delete data relating to the application, among other remedies.

In some instances, a request to check an application (e.g., at 220) may result in a determination that the application has not yet been assessed, for instance, to develop a corresponding reputation score or qualitative assessment of the application. Accordingly, in some examples, a copy of the requested application can be downloaded and assessed (for instance, using reputation engine 20) to determine whether the application should be included in one or more whitelists 30 according to particular policies associated with the respective whitelists 30.

In other implementations, query 220 can include alternate techniques to determine whether an application is in compliance with one or more policies and can be downloaded and/or installed on a mobile device. For example, blacklists can be used in addition to, or in lieu of one or more whitelists 30. In other instances, a reputation system can perform a database lookup and return a reputation score, or a qualitative assessment (e.g., derived based on policies in policies database 28) whether the application is trusted or untrusted. In another example embodiment, reputation engine 20 may provide the trust score and status to the mobile device 14 (e.g., using whitelist enforcement module 22). Based on the information from server 17 (or reputation engine 20), whitelist enforcement module 22 may take appropriate action (e.g., changing configuration of applications on mobile device 14; deleting malicious applications from mobile device 14; generating security alerts on a display of mobile device 14; generating security beeps on speakers of mobile device 14; preventing installation or execution of the malicious application; preventing access to resources in mobile device 14; not taking any security action, etc.) based on the reputation score and analysis data.

Turning to FIG. 3, whitelists (e.g., at 30) (or blacklists) can be used to protect mobile devices against activities, transactions, functions, and other actions performed in connection with one or more applications 34 already installed on a mobile device. While it may be desirable to prevent potentially harmful applications from being installed on mobile devices in a system 10, at least some functionality and updates for existing applications can be prevented based on determinations that corresponding application actions are harmful, insecure, or malicious. For instance, whitelist 30 can maintain a listing of functions, software updates, calls to outside servers (e.g., with untrustworthy reputations or affiliated with known malicious content), and other actions of applications tracked by whitelist server 17. Indeed, whitelists 30 can include a listing of particular actions of particular applications (i.e., identified actions paired with identified applications) that reputation engine 20, for instance, has identified as conforming to one or more policies. Similarly, blacklists can be maintained for particular actions of particular applications that reputation engine 20 has identified as insecure, potentially harmful or malicious, or otherwise violating one or more policies.

Accordingly, in the example of FIG. 3, in response to or prior to an attempt to perform a particular action by a particular application 34 installed on mobile device 14, mobile device 14 can query (e.g., at 230) whitelist server 17 to identify, in one or more whitelists 30, whether the particular action of the particular application 34 is approved according to one or more corresponding policies. In response, whitelist server 17 can provide results of the query indicating if the particular attempted action 225 is allowed and can proceed. If it is determined that the particular action 225 is not included in a corresponding whitelist of approved application actions, the action can be blocked, for instance, at mobile device 14 using whitelist enforcement module 22. Further, in some instances, it can be identified that a particular application action has not yet been assessed, resulting in a risk assessment of the particular application action being completed or scheduled.

In some instances, application actions can involve calls to or communications with outside computing resources, such as a backend application server (e.g., 130). In one illustrative example, an application 34 may attempt to download an update for the application 34 or otherwise communicate data or receive data from an application server 130. In one example, before downloading the update, mobile device 14 (e.g., through whitelist enforcement module 22) can query a whitelist 30 to determine whether the application update is trustworthy. For instance, if the update is not included in a corresponding whitelist, downloading of the update can be terminated. A reputation of the application server 130 or entity associated with the application server 130 can also be considered in determining whether communications and data exchanges with the application server 130 should be whitelisted (and whether the communication is ultimately blocked).

In another example, an application 34 may possess multiple functions ancillary to its principle functions. Some of these functions may be whitelisted functions, while others are not (e.g., because they pose a threat to user privacy, overburden a communication network, are associated with introducing the mobile device to particular threats or vulnerabilities, etc.). Accordingly, portions of an installed application 34 may be approved while others are blocked according to one or more corresponding whitelists 30. In still other examples, it can be identified that a particular application 34 installed on the device is not included in a whitelist of approved applications, and attempts by the application 34 to load into memory or otherwise start and run on the mobile device 14 can be blocked, based on the application's 34 exclusion from a corresponding whitelist 30.

In either of the examples of FIG. 2 or 3, in some instances, rather than querying whitelist server 17 to check actions or applications against a whitelist 30, whitelist server 17 can provide at least a portion of the whitelist 30 to the mobile device 14 for storage or caching on the mobile device 14. This can allow mobile device 14 to protect itself against potential policy violations even when the device is disconnected from a network, such as the Internet. Further, given the memory constraints of mobile devices, a select portion of the whitelist 30 can be identified that corresponds to attributes or use patterns of a particular mobile device or associated user. For instance, mobile device can identify to whitelist server 17 the set of applications installed on the mobile device 14 and whitelist server 17 can provide a customized whitelist to the mobile device outlining approved functions and actions of the set of applications installed on the mobile device 14, among other examples. Further, updates to mobile devices' local whitelist copies can be identified and pulled or pushed to the mobile device to ensure that the mobile device's whitelist is kept current.

According to some embodiments of the present disclosure, the analysis of applications' and application actions' reputations may be rule-based, and may depend on rules set 40. According to embodiments of the present disclosure, rules set 40 may be based on software development kit (SDK) or application programming interface (API) function calls (i.e., expressions consisting of functions and variables or arguments used by the functions). In general, applications (e.g., application 20), may be written to interface with a specific operating system using an API. API is a particular set of rules and specifications including specifications for routines, data structures, object classes, and protocols used to communicate between various software programs. For example, an API can define the operating system's resource request conventions (e.g. function-calling conventions).

An SDK is typically a set of development tools that allows for the creation of applications for a certain software package, software framework, hardware platform, computer system, video game console, operating system, or similar platform. An SDK may include an API (e.g., in the form of files to interface to a particular programming language) and/or sophisticated hardware to communicate with a certain embedded system. Substantially all API function calls may end up in platform SDK function calls. In example embodiments, reputation engine 20 may populate a list with predetermined SDK functions, which a potential malicious user might use.

A rule in rules set 40 may identify paths that a data element (e.g., any named unit of data for processing) can take for a malicious purpose. For example, if a data element uses Media. RecordAudio( ) (i.e., records audio), SmaManager.SendTextMessage( ) (i.e., sends SMS text message), contacts.read( ) (i.e., reads contact list), and httpClient.postData( ) (i.e., contacts an Internet server), in that order, the application may be exhibiting suspicious behavior. However, if a data element uses SmaManager.SendTextMessage( ), contacts. read( ), and httpClient.postData( ), but does not use Media.RecordAudio( ), the application may not be exhibiting suspicious behavior. In an example embodiment, the rules can comprehensively identify all paths that indicate suspicious behavior.

Reputation engine 20 may analyze an application (e.g., application 18) by traversing nodes, including leaf nodes (functions that do not call any other function) in the data flow graph. A rule may include rule elements, which are functions indicating suspicious behavior. For the sake of illustration, assume that an SDK contains functions a( ) . . . z( ), and rules set 40 includes the following rules comprising the specified rule elements: Rule 1: a( ), b( ), p( ), q( ), s( ), to, and z( ), Rule 2: c( ), m( ), n( ), b( ), and to; Rule 3: e( ), o( ), and z( ). Reputation engine 20 may traverse the code flow and data flow graphs for application 18. Each path in the graphs of application 18 typically traverse functions called by application 18. For a given rule, if all rule elements match a path in the graphs (and vice versa), the program logic may be deemed to be suspicious. Such a match may trigger a policy violation for a suitable action. An example policy may include characterizing the application as high risk, or alternatively, setting a trust status as untrusted, and omitting the application or application function from a corresponding whitelist if one or more rule violations are detected.

Turning to calculating reputation scores, functions used by the application (e.g., application 18) may be weighted based on their malice potential. For example, API functions that record audio (e.g., potentially violating users' privacy) may be weighted higher than API functions that read contact lists. Functions with a weighting factor larger than a pre-determined threshold may be denoted as red-flagged functions. Such red-flagged functions can be specifically omitted from application action whitelists (or alternatively included in application activity blacklists). The threshold value may be any value chosen by the user or programmer as appropriate and based on suitable needs. According to embodiments of the present disclosure, a reputation score for an application (e.g., application 18) may be set to 0 at the start of the analysis. Reputation engine 20 may traverse the code flow graph and data flow graph of application 18. Each time the graph path traversal encounters a red-flagged function, the aggregate reputation score for an application may be incremented by the weighting factor of the red-flagged function. At the end of the calculation, the resulting aggregate score can denotes the malice potential of the function call sequence or an application itself. Reputation engine 20, or mobile device 14, may access policies database 28 to identify a suitable action that may be taken with respect to the application based on its reputation score and/or application analysis information.

Reputation scores can be used to build whitelists (and/or blacklists) used to protect against potentially untrustworthy, insecure, or malicious applications and application actions. While numerous servers may be connected to mobile application network 16, server 17 can represent a service providing one or more databases or libraries of whitelists containing information related to applications evaluated for risk. For example, applications evaluated and determined to be untrustworthy (e.g., containing malicious code such as viruses, worms, and the like, etc.) may be included in a so-called “blacklist” (not shown). Applications evaluated and determined to be trustworthy (e.g., uncontaminated, free of malicious code, etc.) may be included in a so-called “whitelist” (e.g., whitelists 30). Although whitelists and blacklists may be implemented separately, it is also possible for them to be combined in a database or library with each software program file being identified as either a whitelist file or a blacklist file. Indeed, libraries of whitelists and blacklists can be assembled and managed by a central reputation system, the whitelists applying to a plurality of different mobile devices, mobile operating systems, mobile device manufacturers, network service providers, enterprises, and other entities and groupings.

Whitelists (and blacklists) may be implemented using checksums where a unique checksum for each application is stored, which can be readily compared to a computed checksum of an application sought to be evaluated. A checksum can be a mathematical value or hash sum (e.g., a fixed string of numerical digits) derived by applying an algorithm to an application (e.g., application program file, application manifest, etc.). If the algorithm is applied to a second application that is identical to the first application, then the checksums should match. However, if the second application is different (e.g., it has been altered in some way, it is a different version of the first application, it is a wholly different type of software, etc.) then the checksums are unlikely to match.

In specific embodiments, a trust status (i.e. trusted or untrusted) of an application is defined as trusted if the application is included in whitelists 30 and untrusted if the application is not included in whitelists 30. Whitelists 30 may include entries identifying each application or application action that is categorized as trusted. In an example embodiment, whitelists 30 may comprise a checksum of application or function fingerprints. In some embodiments, evaluation of applications to determine their respective trust status is performed in real-time for applications associated with an execution attempt in mobile device 14. An execution attempt (e.g., 215 or 225) as used herein in this Specification is intended to include any software process or instruction with an execute request and any attempt to access resources (e.g., processor, memory, camera, microphone, etc.) in the mobile device. When an application is associated with an execution attempt, the execution may be blocked if the trust status of the application is determined to be untrusted (e.g., based on a whitelist or blacklist query). In example embodiments, the trust status may be determined using one of the trusted software inventories (e.g., whitelists 30) or may be determined using one or more trust evaluation techniques in real-time (e.g., using reputation engine 20 and other components). Any execution attempts by untrusted applications may also be logged and aggregated for reporting.

Databases with whitelists 30 in FIG. 1 may be provided by independent third parties and may be regularly updated to provide a comprehensive listing of trustworthy applications available to consumers. Similarly, blacklists (not shown) may be provided by independent third parties and may be regularly updated to provide a comprehensive listing of untrusted, malicious applications. Whitelists and blacklists may be external to network 12 and may be accessible through other networks such as mobile application network 16, or through any other suitable connection that permits electronic communication between network 12 and whitelists 30. Copies of all or portions of such whitelists (or blacklists) can also be provided to corresponding mobile devices 14 themselves for use, for example, by a whitelist enforcement module 22.

According to embodiments of the present disclosure, whitelists 30 may be provisioned in application reputations database 26 (for example, as a local copy), or accessed by or through application reputations database 26, or otherwise available to server 17 and/or mobile device 14 over network 12 (or other networks). Whitelists 30 may also contain information related to applications evaluated for risk and may identify such applications using checksums. Applications identified in whitelists 30 may be inclusive of applications from one or more external whitelists and/or may be customized to provide information on selected applications. In particular, applications developed internally within the organization, but not necessarily available to the general public, may be identified in whitelists 30. Additionally, an internal blacklist could also be provided to identify particular applications evaluated and determined to be untrustworthy. Applications may be organized in any suitable manner in whitelists 30, for example, grouped by publishers or by any other suitable groups.

In example embodiments, whitelist enforcement module 22 may access whitelists 30 (or local copies of whitelists 30) to determine the trust status of application 34. Alternatively, or additionally, whitelist enforcement module 22 may access application reputations database 26 to obtain reputation scores for application 34 (which is already installed in mobile device 14) and application 18 (which is not yet installed in mobile device 14). According to embodiments of the present disclosure, whitelist enforcement module 22 may send application identification (e.g., application manifest) to server 17. In an example embodiment, agent 24 may connect to server 17 over the Internet and get a response over a data connection. In another example embodiment, whitelist enforcement module 22 may dial a predefined number, and send dual-tone multi-frequency (DTMF) tones to transmit application identification information. For example, a hash of the application's identification number (ID) may be computed and converted to an octal representation. The hash can then be transmitted using DTMF tones for numbers 0-7, with a tone for 8 signaling end-of-transmission. The dialed number can then respond with corresponding DTMF tones representing the reputation score that can be used by the agent to determine if the application is trusted or untrusted.

Whitelist enforcement module 22 may collect identification information (e.g., application manifest) of applications to be downloaded (or already downloaded) to mobile device 14, and monitor behavior and activities of any one or more applications already installed on mobile device 14. Whitelist enforcement module 22 may also access policies, which may be stored on mobile device 14 or in policies database 28 in server 17, to determine if any application is malicious or vulnerable to particular threats, and determine any action to take based on reputation scores or application analysis data. Whitelist enforcement module 22 may also manage activities of applications on mobile device 14, for example, by preventing installation of one or more applications or application updates or preventing execution of one or more applications or application actions based on the respective reputation scores of the applications, their updates, or actions. In example embodiments, whitelist enforcement module 22 may comprise a kernel module residing in (or be operable by) operating system (not shown) of mobile device 14.

In an example embodiment, whitelist enforcement module 22 may include event detection capabilities, communication interfaces, policy manager, etc. In another example embodiment, whitelist enforcement module 22 may include software capable of communicating with reputation engine 20 and server 17, and carrying out instructions from policy managers, event detection components, etc. Whitelist enforcement module 22 may be configured to receive queries or information from reputation engine 20 and/or server 17. For example, reputation engine 20 may query whitelist enforcement module 22 for a status of one or more applications installed in mobile device 14. Whitelist enforcement module 22 may provide application status to reputation engine 20 in response to the query. In another example, reputation engine 20 may provide whitelist enforcement module 22 with a reputation score of application 18. In response, whitelist enforcement module 22 may lookup a policy and take a suitable action based on the reputation score.

In another example embodiment, application reputations database 26 may include whitelists 30 of trustworthy applications, for example, applications with a low reputation score, or trusted status. Whitelist enforcement module 22 may compare an application (e.g., application 34 or application 18) with whitelists 30. If the application is not found in whitelists 30, the application may be deemed to be untrusted and may not be allowed to download (if not downloaded) or run (if already downloaded). In some embodiments, mobile device 14 may be booted to enable the functionalities described herein.

In some embodiments, the aggregated application fingerprints may include aggregated behaviors of the application that may also be evaluated to determine a reputation score of the application. As more information about an application or actions of applications are reported or otherwise made available to reputation engine 20, a statistical confidence level of the reputation score may be higher. For instance, whitelist enforcement modules 22 operating mobile devices 14 in a system can detect security events relating to particular applications and application activities and report such events to reputation engine 20 or other modules for use in determining the trustworthiness of such applications and application activities. Indeed, knowledge gained from monitoring application activity on any one mobile device may be aggregated and analyzed against information about similar activity obtained from other mobile devices, and correlated with data from other vectors (e.g., file, web, message, network connections, and manual efforts) for substantially comprehensive information about the application. In an example embodiment, the data from other vectors may be derived from threat intelligence feeds 32. Additionally, any threat or vulnerability may be temporal in nature (e.g., if an application is interacting with an IP address that is temporarily compromised), and components of system 10 may modify the application's reputation score appropriately in real time to remediate the threat to the host mobile device. For example, reputation engine 20 may incorporate and adjust reputation scores with each additional data point.

In an example scenario, if a new application pops up in a particular geographic location (e.g., China) and it spreads like wildfire within hours (e.g., application is downloaded and installed to an unusually large user base or user bases in atypical markets, for instance, installations on several hundred thousand mobile devices geographic locations, such as United States, Europe, Australia, India, etc. in a short span of time), such fast and atypical distribution may be interpreted to be an indicator of malicious behavior, and a reputation score for the new application may be generated or updated to reflect this characteristic. Reputation engine 20 may aggregate such information, analyze it, and determine that a propagation factor (i.e., how quickly the application spreads to other mobile devices) of the application is high, indicating possible malicious behavior.

In another example scenario, an application on a particular mobile device may initiate a spying or snooping action. A whitelist enforcement module 22 may recognize the snooping action and convey the snooping action to reputation engine 20. Consequently, reputation engine 20 may calculate an updated reputation score for the application. The updated reputation score may be distributed to all other mobile devices on which the application is installed, enabling respective agents to take suitable action.

Turning to the infrastructure of FIG. 1, server 17 may be an enterprise server managing security and policies of a particular enterprise. In another embodiment, server 17 may be one or more intermediate servers provided, for instance, through a third-party computer security services vendor. FIG. 1 showing mobile device 14 communicating with mobile application network 16 through server 17 is merely representative. One or more servers may be used for one group of associated mobile devices (e.g., mobile devices on an enterprise, or having a common local communications carrier, etc.); and multiple enterprises or groups of associated mobile devices may connect to the cloud through their own one or more servers.

Network 12 represents networks, which can be a series of points or nodes of interconnected communication paths for receiving and transmitting packets of information that propagate through system 10. Network 12 offers communicative interfaces between any of the components of FIG. 1. Network 12 could be any local area network (LAN), wireless local area network (WLAN), wide area network (WAN), wireless wide area network (WWAN), metropolitan area network (MAN), wireless metropolitan area network (WMAN), wireless single hop or multi-hop network, virtual private network (VPN), Intranet, Extranet, or any other appropriate architecture or system that facilitates communications in a network environment. Network 12 may include any suitable communication link to reputation engine 20 such as wireless technologies (e.g., IEEE 802.11, 802.16, WiFi, Bluetooth, WiMax, DSRC, WiMAX, etc.), satellite, cellular technologies (e.g., 3G, 4G, etc.), etc., or any combination thereof. Network 12 may also include configurations capable of transmission control protocol/Internet protocol (TCP/IP) communications, user datagram protocol/IP (UDP/IP), or any other suitable protocol, where appropriate and based on particular needs.

Not shown in system 10 of FIG. 1 is hardware that may be suitably coupled to reputation engine 20 in the form of consoles, user interfaces, memory management units (MMU), additional symmetric multiprocessing (SMP) elements, peripheral component interconnect (PCI) bus and corresponding bridges, small computer system interface (SCSI)/integrated drive electronics (IDE) elements, etc. In addition, suitable modems, routers, base stations, wireless access points, and/or network adapters may also be included for allowing network access by components of system 10. Any suitable operating systems may also be configured in components of system 10 to appropriately manage the operation of hardware components therein. Components of system 10 may include any other suitable hardware, software, components, modules, interfaces, or objects that facilitate the operations thereof. This may be inclusive of appropriate algorithms and communication protocols that facilitate the operations detailed herein. These elements, shown and/or described with reference to system 10 are intended for illustrative purposes and are not meant to imply architectural limitations. In addition, each element, including reputation engine 20, agents 24 and mobile devices 14, may include more or less components where appropriate and based on particular requirements.

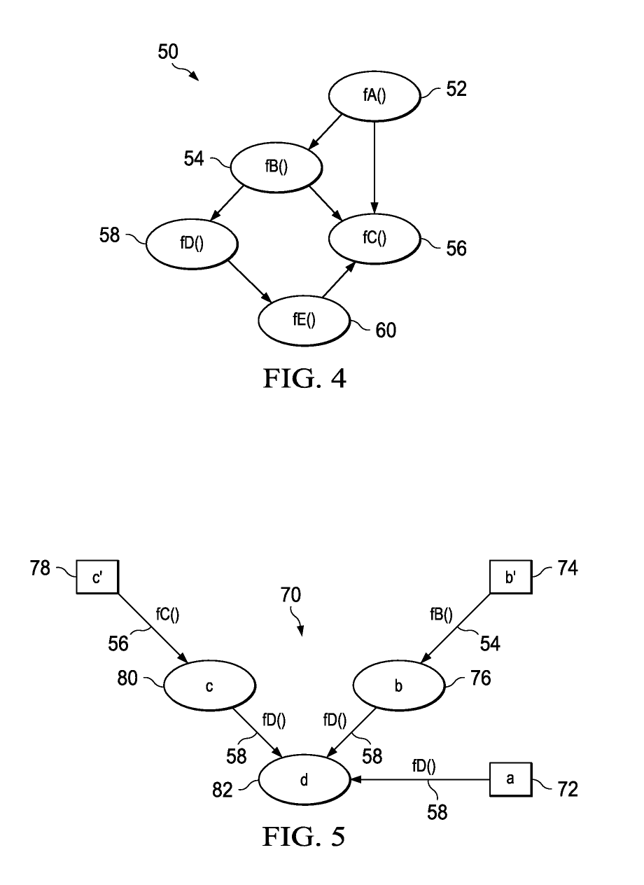

Turning to FIG. 4, FIG. 4 is an example code flow graph or call graph for use in some implementations of a reputation engine. A call graph can be a directed graph that represents calling relationships between functions in a computer program. A call graph can be used, for instance, to automatically parse, test, simulate, and otherwise examine application functions and identify untrustworthy, insecure, or other undesirable application features. Further, the identification of undesirable functionality within an application can serve as the basis for a lower overall reputation score for the application or the identified application functions. In some instances, a call graph can include nodes and edges. Specifically, each node represents a procedure and each edge (f, g) indicates that procedure f calls procedure g. For purposes of illustration, assume that functions named fA( ), fB( ), fC( ) etc. are called in a sequence as follows: fA( ){fB( ), fC( )} (i.e., fA( ) calls functions fB( ) and fC( )); fB( ){fD( ); fC( );} (i.e., fB( ) calls functions fD( ) and fC( )); fC( ){calculation}(i.e., fC( ) performs a calculation); and fD( ){fE( ){fC( )}}(i.e., fD( ) calls function fE( ) which calls fC( ).

The resultant call graph 50 may be as illustrated in FIG. 5. Function fA( ) 52 may call functions fB( ) 54 and fC( ) 56. Function fB( ) 54 may call functions fC( ) 56 and fD( ) 58. Function fD( ) 58 may call function fE( ) 60, which in turn calls fC( ) 56. The code flow graph can have leaf nodes (functions that do not call any other function, like fC( ) 56 in above example). Leaf nodes can either be (a) an application writer's function that performs some calculation; or (b) system calls/SDK functions like those in the Android SDK. The SDK functions may not call internal functions within the application's code. In example embodiments wherein applications for Android OS are written using Java SDK, system calls may be discounted from the analysis, as in the example illustrated herein.

Turning to FIG. 5, FIG. 5 is an example data flow graph 70 according to embodiments of the present disclosure. A data flow graph typically has nodes and edges. Nodes receive data or describe operations (e.g., nodes can be program statements), and transmit values to other nodes by way of edges. Edges may be considered to be channels of communication, for instance. A circle in a data flow graph typically represents a process (e.g., a set of program sets). An arrow directed towards the circle represents a data input (or set of inputs) and an arrow originating from the circle represents a data output (or a set of outputs). Data input along an input edge is considered as a token. Nodes consume tokens (e.g., of type Boolean, integer, real or character) on input edges and produce tokens on output edges. Mathematically, the following representation may be adopted:

G= [symbol] N,E

[symbol]

where G is the data flow graph, N={n₁, n₂, . . . , nₙ} is the set of nodes, and E is the set of edges.

Reputation engine 20 may parse the application under analysis (e.g., application 18). Parsing is a process of analyzing a source code of a computer program and creating some form of internal representation. In example embodiments, reputation 20 may parse the decompiled source code of application 18 and create data flow graph 70, with a node for each variable that is encountered, and an edge for each operation. Variables may be operated on in a program to result in some other variable.

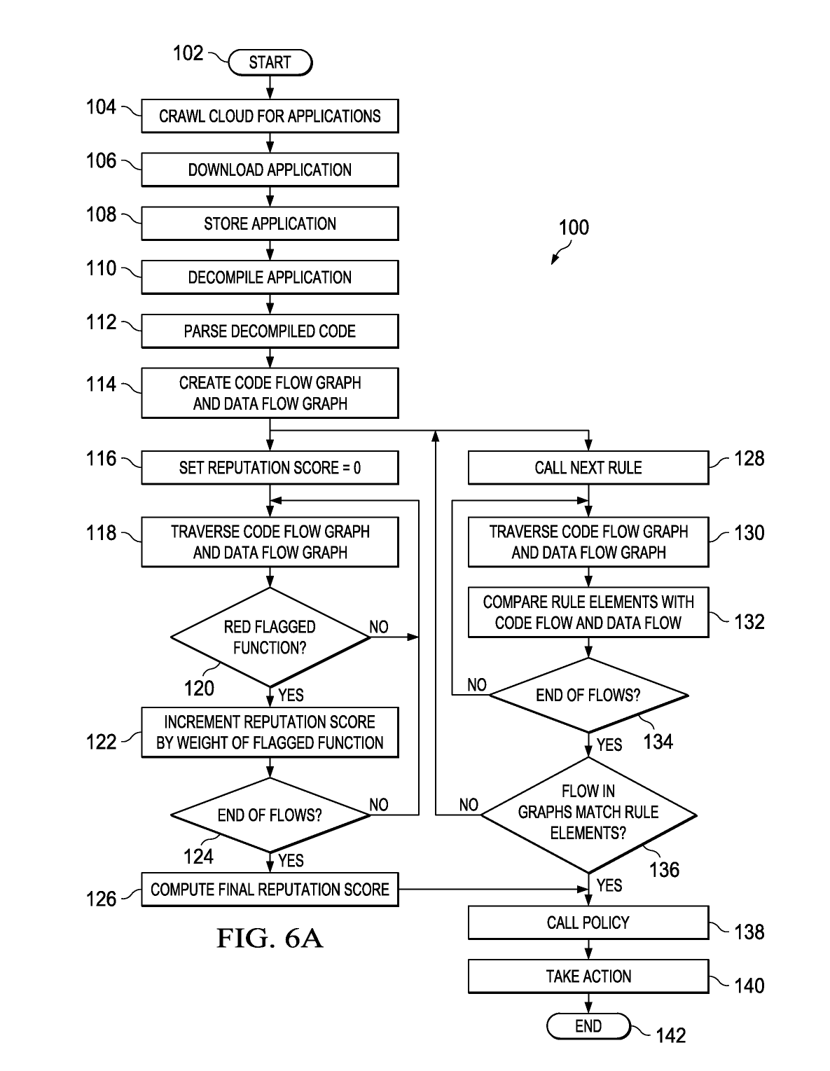

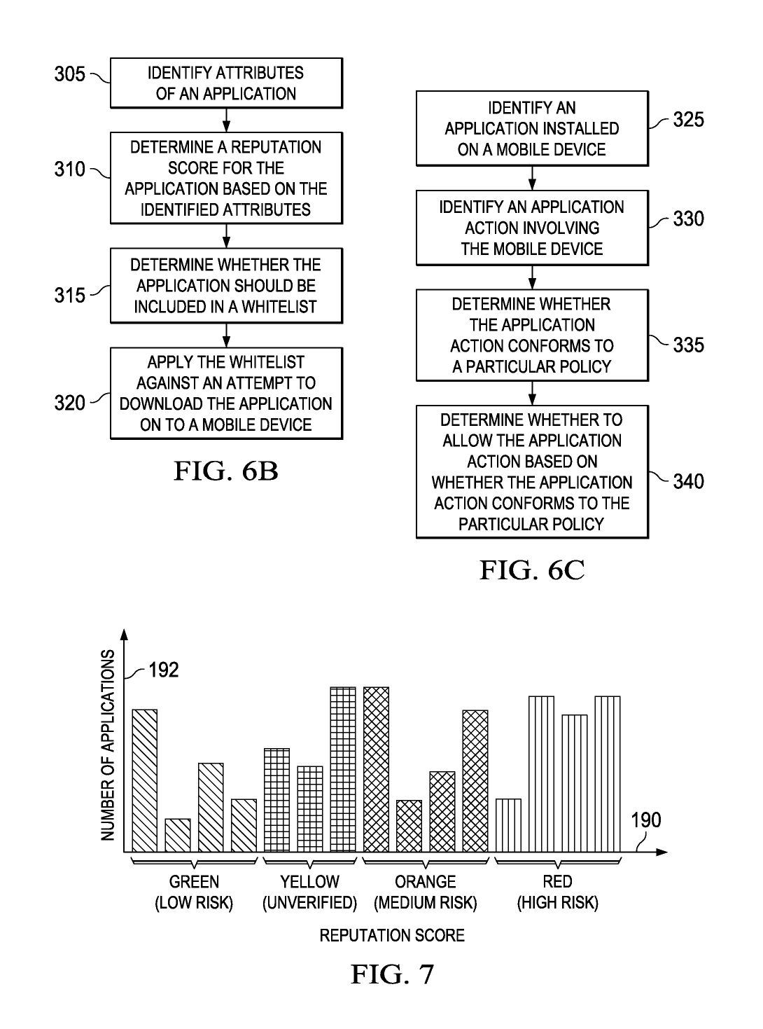

For example, according to FIG. 6A, assume that application 18 comprises a code including functions fA( ) (not shown), fB( ) 54, fC( ) 56 and fD( ) 58 operating on variables a 72, b 76, c 80 and d 82, all of which are integers. Integer a 72 is assigned a value of 100. Integer b 76 may be obtained by operating another function fB(b′) 54 on variable b′ 74. Integer c 80 may be obtained by operating yet another function fC(c′) 56 on variable c′ 78. Integer d 82 may be obtained by operating yet another function fD(a, b, c) 58 on variables a 82, b 76 and c 80. Function fA( ) may be mathematically represented as follows:

fA( )
{

Int a = 100;
Int b = fB( );
Int c = fC( );
Int d = fD(a,b,c);

}

The set of nodes and edges defined by the above described variables can result in data flow graph 70 as illustrated in FIG. 5.

Turning to FIG. 6A, FIG. 6A is a flow chart illustrating example operational steps that may be associated with embodiments of the present disclosure. Operations 100 start in 102, when reputation engine 20 is activated. Reputation engine 20 may crawl mobile application network 16 for applications (e.g., application 18) in 104. In an example embodiment, reputation engine 20 may crawl the Internet for applications. In another example embodiment, reputation engine 20 may crawl an enterprise network for applications. In yet another example embodiment, reputation engine 20 may crawl known websites or application software distribution platforms for applications.

In 106, reputation engine 20 may download application 18 and in 108, reputation engine 20 may store application 18. Reputation engine 20 may store application 18 in a file server, application server, network drive, or any other device or network element that may be suitable to store program files such as those contained in application 18. In an example embodiment, reputation engine 20 may store a checksum of application fingerprints, rather than the entire application. In yet another example embodiment, reputation engine 20 may store the application manifest, rather than the entire application.

In 110, reputation engine 20 may decompile application 18 by any known method. Decompiling may not reconstruct the original source code of application 18; however, it may provide information about the operations and variables in application 18, sufficient to perform the functions as described herein. In 112, reputation engine 20 may parse the decompiled code and obtain functions used by application 18. In 114, reputation engine 20 may appropriate create code flow graphs and data flow graphs of application 18.

In 116, a reputation score of an application 18 (or identified application functions, operations, or other actions identified during decompiling 110 and parsing 112) can be calculated. For instance, in one example, a reputation score can be initially set to 0 (or initialized in any suitable manner). In 118, reputation engine 20 traverses the code flow graph and data flow graph, seeking red-flagged functions. Each time the graph path traversal encounters a red-flagged function, as determined in 120, the reputation score may be incremented by the weighting factor of the red-flagged function. For example, if Media.RecordAudio( ) function is assigned a weighting factor of 10, and SmaManager.SendTextMessage( ) function is assigned a weighting factor of 8, and contacts.read( ) function is assigned a weighting factor of 5, an application that includes all three functions may have a reputation score of 23. On the other hand, an application that includes only contacts.read( ) function and the SmaManager.SendTextMessage( ) function may have a reputation score of 13. When an end-of-flow is encountered in 124, reputation engine 20 may calculate a final reputation score, for example, by aggregating the weighting factors of all red-flagged functions encountered.

In 128, reputation engine 20 may call a (next) rule from rules set 40. In 130, reputation engine 20 may traverse the code flow graph and data flow graph of application 18. In 132, application 18 may compare rule elements with the code flow and data flow graphs. In 134, if an end-of-flow is encountered, reputation engine determines whether the flow in the graphs (i.e., code flow graph and data flow graph) match the rule elements in 136. Operations continue to 128, wherein the next rule is called. Reputation engine 20 may go through all rules in rules set 40 until the code flow graph and data flow graphs have been analyzed against all rules in rules set 40.

If a match is found (indicating malicious behavior), a policy may be called in 138. In example embodiments, the policy may be called by agent 24 in mobile device 14. In another example embodiment, the policy may be called by reputation engine 20, which may apply the policy on application 18 and place it in whitelists 30 if the reputation score is low. In 140, any suitable action may be taken. For example, whitelist enforcement module 22 may cause mobile device 14 to uninstall the application (if it has already been installed). In another example, whitelist enforcement module 22 may cause a security alert to be displayed on a screen of mobile device 14, indicating that the application is malicious. Any appropriate action may be taken based on suitable needs. The operations end in 142.

Turning to FIG. 6B, a flowchart is shown showing example techniques used to assess an attempt to download a particular application onto a mobile device. For instance, attributes of the application can be identified 305, for example, in connection with the crawling of libraries of applications identified as operable with one or more mobile devices, such as smartphones, tablet computers, PDAs, electronic readers, and other mobile devices of various makes, models, and operating systems. The particular application can be assessed, along with every other application discovered during the crawling, to identify attributes of the application, including the developer of the application, an identity of the server of the application, functions of the application, backend computing resources used by the applications, reported events relating to the applications, among other attributes discoverable during crawling and analysis of the respective applications. In one illustrative example, attributes, such as application functions and actions of an application can be identified, for instance, through simulation, testing, decompiling, and/or parsing of the application. Additional attributes for the application can be identified in connection with discovery of the application such as identification of the server or source of the application, the developer of the application, when the application was first made available, among other attributes. For instance, an identity of the application's seller, server, or developer can be identified. Further a reputation of the application's source or developer can be identified and considered along with other attributes in determining the application's trustworthiness or compliance with one or more mobile application policies enforced in a network or system.

Further, a reputation score can be determined 310 for the particular application (and all other identified applications) based on the identified attributes. A plurality of reputation scores can be determined 310 for the particular application according to various rules and policies, including rules and policy sets corresponding to different entities, such as network service providers, device manufacturers, enterprise system managers, and so on. The determined reputation score can be used to determine 315 whether applications should be included in one or more whitelists identifying, for example, whether the application conforms to a particular set of policies or rules. For instance, whether an application is added to a whitelist can depend on whether the determined reputation score meets a certain threshold of trustworthiness, satisfies various policies or rules, among other examples. The whitelist can be used to protect mobile devices from potentially untrustworthy applications and threats and vulnerabilities potentially introduced through such applications. In other instances, the whitelist can be used to enforce particular mobile device application policies, such as policies or rules of a particular service provider or other entity.

As an example, the whitelist can be used 320 to assess attempts to download an application onto a particular mobile device. For instance, if the application is included in a whitelist, downloading of the application onto the particular mobile device may proceed uninhibited. Alternatively, if the application is not included in the whitelist, downloading of the application can be blocked, for instance, at the mobile device, a network gateway used by the mobile device, or some other computing component. Multiple whitelists may be developed and maintained and in some instances a single application may be included on some whitelists but omitted from others, for instance, based on the particular policies governing applications' inclusion in a corresponding whitelist.

FIG. 6C shown another flowchart illustrating example techniques for assessing the trustworthiness or policy compliance of one or more actions of applications installed on one or more mobile devices. An installed application can be identified 325 on a mobile device. An application action can be identified 330 involving the mobile device, for instance, in connection with an attempt to perform the action using the mobile device. A determination can be made 335, for instance using a whitelist or a blacklist, whether the identified application action conforms with a particular policy. The policy can be included in a set of policies or rules of a particular entity. Based on the determination 335, the application action can be allowed or blocked (at 340). For instance, such application actions can include attempts to download a particular update, an attempt to access a particular outside computing resource or server (e.g., with its own respective reputation), an attempt to perform a particular function, string of functions, or operation, or even an attempt to begin running the application, among other examples.

Turning to FIG. 7, FIG. 7 is a bar chart illustrating reputation score 190 on the X-axis against number of applications 192 along the Y-axis. Reputation score 190 may be classified into a plurality of categories. In an example embodiment, low reputation scores may be classified as low risk, and assigned a color green. Reputation scores reflecting an unverified status may be assigned a color yellow. Intermediate reputation scores may be classified as medium risk and assigned a color orange. High reputation scores may be classified as high risk and assigned a color red. For each reputation score (or range of reputation scores), there may be several corresponding applications. For example, a number of applications 192 may have an identical reputation score (or range of reputation scores), which may be different from another number of applications with a different reputation score.

Suitable actions may be taken based on the risk level. For example, applications with reputation scores in the high risk category may not be allowed to download, or install, or run. On the other hand, applications with reputation scores in the low risk category may be allowed to download, install, and run. Any number of suitable actions may be taken based on the risk categories of the applications. The colors are provided for illustrative purposes only. Any other classification labels, means, schemes and methods may be used without changing the scope of the present disclosure.

Although the embodiments described herein have referred to applications, it will be apparent that other sets of program files may be evaluated and/or remediated using system 10. The options for whitelisting applications, as shown in FIGURES, are for example purposes only. It will be appreciated that numerous other options, at least some of which are detailed herein in this Specification, may be provided in any combination with or exclusive of the options of the various FIGURES.

Software for achieving the operations outlined herein can be provided at various locations (e.g., the corporate IT headquarters, end user computers, web servers, distributed servers in the cloud, software security provider cloud or datacenter, etc.). In some embodiments, this software could be received or downloaded from a web server (e.g., in the context of purchasing individual end-user licenses for separate networks, devices, servers, etc.) in order to provide this system. In one example implementation, this software is resident in one or more mobile devices, computers and/or servers sought to be protected from a security attack (or protected from unwanted or unauthorized manipulations of data).

System 10 may be implemented in hardware or software, and may be used to assess applications either remotely or locally. In an example embodiment, system 10 may be implemented as a cloud component and local agents on various mobile devices, wherein the local agents perform collecting information (e.g., application code information), monitoring (e.g., application behavior), and enforcing functions and the cloud component receives the application code information, determines reputation scores and pushes reputation scores back to the mobile devices. In another embodiment, system 10 may be implemented as a remote automated service that can scan a targeted mobile device according to a pre-determined schedule, for example, once every 24 hours. In yet another example embodiment, system 10 may be implemented as a portable solution that can be temporarily loaded onto a network connected to a target mobile device. System 10 may perform a deep inspection of applications on myriad mobile devices. In yet another example embodiment, system 10 may be hosted on a mobile device.

In various embodiments, the software of the system for whitelisting applications could involve a proprietary element (e.g., as part of a network security solution with security management products), which could be provided in (or be proximate to) these identified elements, or be provided in any other device, server, network appliance, console, firewall, switch, information technology (IT) device, distributed server, etc., or be provided as a complementary solution, or otherwise provisioned in the network. In various embodiments, mobile application network 16 may include one or more servers running proprietary software.

In certain example implementations, the activities outlined herein may be implemented in software. This could be inclusive of software provided in reputation engine 20 and in other network elements (e.g., mobile devices 14) including applications. These elements and/or modules can cooperate with each other in order to perform the activities as discussed herein. In other embodiments, these features may be provided external to these elements, included in other devices to achieve these intended functionalities, or consolidated in any appropriate manner. For example, some of the processors associated with the various elements may be removed, or otherwise consolidated such that a single processor and a single memory location are responsible for certain activities. In a general sense, the arrangement depicted in FIGURES may be more logical in its representation, whereas a physical architecture may include various permutations, combinations, and/or hybrids of these elements.

In various embodiments, some or all of these elements include software (or reciprocating software) that can coordinate, manage, or otherwise cooperate in order to achieve operations, as outlined herein. One or more of these elements may include any suitable algorithms, hardware, software, components, modules, interfaces, or objects that facilitate the operations thereof. In the implementation involving software, such a configuration may be inclusive of logic encoded in one or more tangible media, which may be inclusive of non-transitory media (e.g., embedded logic provided in an application specific integrated circuit (ASIC), digital signal processor (DSP) instructions, software (potentially inclusive of object code and source code) to be executed by a processor, or other similar machine, etc.).

In some of these instances, memory can store data used for the operations described herein. This includes the memory being able to store software, logic, code, or processor instructions that are executed to carry out the activities described in this Specification. A processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

Reputation engine 20 and other associated components in system 10 can include memory for storing information to be used in achieving operations as outlined herein. These devices may further keep information in any suitable type of memory (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory.’ Similarly, any of the potential processing elements, modules, and machines described in this Specification should be construed as being encompassed within the broad term ‘processor.’ Each of the computers may also include suitable interfaces for receiving, transmitting, and/or otherwise communicating data or information in a network environment.

Note that with the numerous examples provided herein, interaction may be described in terms of two, three, four, or more network elements and modules. However, this has been done for purposes of clarity and example only. It should be appreciated that the system can be consolidated in any suitable manner. Along similar design alternatives, any of the illustrated computers, modules, components, and elements of FIG. 1 may be combined in various possible configurations, all of which are clearly within the broad scope of this Specification. In certain cases, it may be easier to describe one or more of the functionalities of a given set of flows by only referencing a limited number of network elements. It should be appreciated that the system of FIG. 1 (and its teachings) is readily scalable and can accommodate a large number of components, as well as more complicated/sophisticated arrangements and configurations. Accordingly, the examples provided should not limit the scope or inhibit the broad teachings of system 10 as potentially applied to a myriad of other architectures.

It is also important to note that the operations described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

What is claimed is:

1. A method comprising:
identifying one or more attributes of an application in a plurality of applications;
determining a reputation score of the application based at least in part on the identified attributes;
determining whether the application should be included in a first whitelist; and
applying the whitelist against a request to download the application on a mobile device.

2. The method of claim 1, wherein at least one first policy is associated with the first whitelist and determining whether the application should be included in the first whitelist is based at least in part on compliance of the application with the at least one first policy.

3. The method of claim 2, wherein the first whitelist is associated with a first entity, the method further comprising determining whether the application should be included in a second whitelist associated with a second entity based at least in part on compliance of the application with the at least one second policy.

4. The method of claim 2, wherein the first policy is one of a plurality of policies, and each policy in the plurality of policies is associated with a particular mobile device manufacturer.

5. The method of claim 2, wherein the first policy is one of a plurality of policies, and each policy in the plurality of policies is associated with a particular mobile network service provider.

6. The method of claim 1, wherein determining whether the application should be included in a first whitelist includes determining whether the reputation score indicates a level of trustworthiness above that of a threshold reputation score for the first whitelist.

7. The method of claim 1, further comprising:
obtaining a plurality of applications, including the application, from at least one application source; and
determining, for each application in the plurality of applications, whether the respective application should be included in the first whitelist.

8. The method of claim 7, wherein the plurality of applications includes at least one application operable on a first operating system and at least one other application operable on a second, different operating system.

9. The method of claim 1, wherein the application is determined to be omitted from the first whitelist and applying the first whitelist includes blocking the downloading of the application on to the mobile device.

10. The method of claim 1, wherein applying the first whitelist includes downloading at least a portion of the first whitelist on the mobile device for use by the mobile device in determining whether to allow downloading of at least the application on the mobile device.

11. The method of claim 1, wherein identifying one or more attributes of the application includes executing the application in a test environment and observing functionality of the application.

12. The method of claim 1, wherein determining the reputation score of the application includes:
identifying a developer of the application;
identifying a reputation for the developer, wherein the reputation score of the application is based, at least in part, on the reputation for the identified developer.

13. The method of claim 12, wherein the reputation for the developer is based on reputation scores of other applications associated with the developer.

14. The method of claim 1, wherein identifying one or more attributes of the application includes identifying one or more events relating to deployment of the application on one or more mobile devices.

15. The method of claim 14, wherein the events identify at least one negative security event detected by the one or more mobile devices in connection with operation of the application on the one or more mobile devices.

16. The method of claim 14, wherein the events identify one or more network connections made by the application with particular remote server devices.

17. The method of claim 16, wherein identifying one or more attributes of the application further includes identifying a reputation of the particular remote server devices.

18. The method of claim 1, wherein the application is adapted for operation on each of a plurality of versions of a particular operating system.

19. The method of claim 1, wherein identifying one or more attributes includes:
identifying one or more functions of the application; and
determining if the application includes one or more functions included in a set of undesirable functions.

20. The method of claim 19, wherein identifying one or more functions of the application includes:
decompiling the application to obtain a decompiled code;
parsing the decompiled code; and
creating a code flow graph and a data flow graph.

21. Logic encoded in non-transitory media that includes code for execution and when executed by a processor is operable to perform operations comprising:
identifying one or more attributes of an application in a plurality of applications;
determining a reputation score of the application based at least in part on the identified attributes;
determining whether the application should be included in a first whitelist; and
applying the whitelist against a request to download the application on a mobile device.

22. A system comprising:
a memory configured to store data; and
a processor operable to execute instructions associated with the data;
a mobile application approval engine, adapted when executed by the at least one processor device to:
identify one or more attributes of an application in a plurality of applications;
determine a reputation score of the application based at least in part on the identified attributes;
determine whether the application should be included in a first whitelist; and
apply the whitelist against a request to download the application on a mobile device.

23. The system of claim 22, wherein the first whitelist includes a plurality of applications approved for download onto any one of a particular set of mobile devices.
